(19) United States
(12) Patent Application Publication
(10) Pub. No.: US 2013/0307829 A1
(43) Pub. Date: Nov. 21, 2013

(54) HAPTIC-ACOUSTIC PEN

(71) Applicant: EVERNOTE CORPORATION, Redwood City, CA (US)

(72) Inventor: Phil LIBIN, San Jose, CA (US)

(73) Assignee: Evernote Corporation, Redwood City, CA (US)

(21) Appl. No.: 13/777,272

(22) Filed: Feb. 26, 2013

Related U.S. Application Data
(60) Provisional application No. 61/647,767, filed on May 16, 2012.

(51) Int. Cl. G06F 3/01

(52) U.S. Cl. CPC G06F 3/016
USPC 345/179

(57) ABSTRACT

A pen for annotating an electronic screen includes a shell, a tip provided at one end of the shell, and a haptic generator, provided in the shell, that provides vibration of the tip and the shell to emulate resistance of different simulated writing surfaces. The vibration provided by the haptic generator may correspond to friction, abrasion, and flexure of the simulated writing surfaces. The vibration provided by the haptic generator may be based on pre-recorded feedback that is reproduced by the haptic generator. The vibration provided by the haptic generator may be based on a dynamic position of the tip on the electronic screen. The pen may also include an inductor/capacitor, disposed within the shell, that interacts with antenna coils of the electronic screen to provide the dynamic position of the tip on the electronic screen.

### CROSS-REFERENCE TO RELATED APPLICATIONS

This application claims priority to U.S. Prov. App. No. 61/647,767, filed May 16, 2012, and entitled “HAPTIC-ACOUSTIC PEN,” which is incorporated herein by reference, which is incorporated herein by reference.

### TECHNICAL FIELD

This application is directed to the fields of human-machine interaction on mobile devices and presentation of visual and other information on such devices, and more particularly to the field of digital pens and the interaction of digital pens with tablet computers.

### BACKGROUND OF THE INVENTION

In 2011-2012, over a hundred million people have been using tablets with touch sensitive screens, including top-selling models, such as the Apple iPad, Amazon Kindle Fire or Samsung Galaxy Tab. According to market forecasts, tablet usage will rapidly increase to almost half-a-billion units by 2015, with productivity applications growing at an accelerated pace. Screen resolution of mobile devices is reaching the level of maximum human eye resolution of about 300 PPI; accordingly, screens with such pixel density may well justify the name of “retina displays”. This makes contemporary tablets already as good as paper for viewing the displayed content. Additionally, many contemporary tablets have multi-touch surfaces, which stimulate writing, finger and pen manipulations with screen objects, device control using multi-touch gestures, etc. In particular, a combination of a high-resolution display with an instant writing capability makes tablets nearly ideal handwriting devices for note-taking In response to increasing user demand, numerous models of styluses and pens have been designed for tablets running iOS, Android and other mobile operating systems; examples include Wacom Bamboo Stylus, Adonit Jot, Pogo Stylus and Sketch Pro, etc. Additionally, freehand note-taking applications, such as Penultimate, Notability, Notes Plus, Noteshelf and many other similar programs with handwritten input are making good use of tablet styluses.

The closer to habitual pen and paper experiences, the more natural is user acceptance of the new electronic paper. Adapting to user demand, handwriting applications are increasingly offering rich stationery and enhanced set of writing/drawing tools that render visual appearance of background and hand drawn lines and shapes.

However, tablet user experience with existing writing instruments and multi-touch screens is often limited to the visual feedback and ignores important tactile and audio aspects of the conventional handwriting process, the feel and sound of writing. Accordingly, it is desirable to develop an easily available and inexpensive systems and methods for enhancing handwriting experiences of digital pen users.

### SUMMARY OF THE INVENTION

According to the system described herein, a pen for annotating an electronic screen includes a shell, a tip provided at one end of the shell, and a haptic generator, provided in the shell, that provides vibration of the tip and the shell to emulate resistance of different simulated writing surfaces. The vibration provided by the haptic generator may correspond to friction, abrasion, and flexure of the simulated writing surfaces. The vibration provided by the haptic generator may be based on pre-recorded feedback that is reproduced by the haptic generator. The vibration provided by the haptic generator may be based on a dynamic position of the tip on the electronic screen. The pen may also include an inductor/capacitor, disposed within the shell, that interacts with antenna coils of the electronic screen to provide the dynamic position of the tip on the electronic screen. The inductor/capacitor may provide information regarding pressure and pen tilt which is used to vary the vibration provided by the haptic generator. The pen may also include a processor that models physical interaction of a selected emulated drawing tool with the simulated writing surface to provide instructions to the haptic generator based on the information regarding pressure and pen tilt. The pen may also include ultrasound technology, disposed within the shell, that provide the dynamic position of the tip on the electronic screen. The ultrasound technology may provide information regarding pressure and pen tilt which is used to vary the vibration provided by the haptic generator. The pen may also include a processor that models physical interaction of a selected emulated drawing tool with the simulated writing surface to provide instructions to the haptic generator based on the information regarding pressure and pen tilt. The pen may also include an acoustic generator, provided in the shell, that provides an audio feedback to emulate sound created when writing on the different simulated writing surfaces. The sound may be a squeak of a writing quill and/or a rustle of a painting brush. The pen may also include an embedded processing unit, provided in the shell and coupled to the haptic generator, that processes incoming signals, calculates feedback characteristics and sends instructions to the haptic generator. Processing for signals provided to the haptic generator may be provided by a device containing the electronic screen.

According further to the system described herein, providing feedback to a user actuating a pen on an electronic screen includes determining dynamic characteristics of handwritten trajectory for modeling a physical behavior of a writing tool chosen by the user and actuating the pen with a haptic generator according to the dynamic characteristics of handwriting trajectory. The dynamic characteristics of handwriting trajectory may include coordinates, pressure, tilt, speed and acceleration of a tip of the pen. A processor on the pen may determine the dynamic characteristics of handwriting trajectory. Providing feedback to a user actuating a pen on an electronic screen may also include actuating an acoustic generator of the pen according to the dynamic characteristics of handwriting trajectory.

According further to the system described herein, computer software, provided in a non-transitory computer-readable medium, provides feedback to a user actuating a pen on an electronic screen. The software includes executable code that determines dynamic characteristics of handwritten trajectory for modeling a physical behavior of a writing tool chosen by the user and executable code that actuates the pen with a haptic generator according to the dynamic characteristics of handwriting trajectory. The dynamic characteristics of handwriting trajectory may include coordinates, pressure, tilt, speed and acceleration of a tip of the pen. A processor on the pen may determine the dynamic characteristics of handwriting trajectory. The computer software may also include executable code that actuates an acoustic generator of the pen according to the dynamic characteristics of handwriting trajectory.

A self-powered pen device with haptic and possibly audio generators, which can write on a tablet screen, is capable of recognizing a selected paper type, writing surface, and writing/drawing tool of customized handwriting software application(s) running on tablet. During writing and drawing by a user, such a haptic-acoustic pen follows software settings and generates tactile and possibly also audio feedback to the user, which simulates real-life experiences of writing or drawing on that paper or on other surfaces with a conventional ballpoint, fountain or other pen, as well as with a pencil, brush or other tool.

The handwriting software application running on a tablet device may have a variety of writing and drawing backgrounds and tools. Backgrounds may emulate diverse types of paper, such as scratch paper, papyrus paper, chalk paper, as well as cardboard, glass, wood, metal, stone and other types of surfaces. Correspondingly, the software may allow employing different tools for writing and drawing on different surfaces, including pen, pencil, brush, chisel, chalk, etc. Note that, in the physical world, each interaction of a drawing tool with a surface produces its own unique visual, haptic and audible feel.

The existing handwriting software applications may reproduce visual components as rendered lines and other drawing objects on the screen. Haptic and audio components for particular combinations of real-life writing surfaces and drawing tools may be recorded, analyzed, modeled and stored as software application data in the form of haptic and audio profiles. In an embodiment, each profile includes parameters and instructions sufficient to reproduce the haptic and possibly audio feedback for a particular combination of a writing surface and a tool, which may depend on the dynamics of the writing trajectory, including writing speed, pressure, tilt, jitter and other factors.

When a user of the handwritten software application changes the current drawing background (surface, material) and/or the drawing tool, the system may change the corresponding haptic and/or audio profile(s), provided that corresponding profiles are available for the new combination of the surface and the tool; respectively, the haptic and/or audio feedback to user handwriting may also change, enhancing usage experiences.

The haptic feedback component may be provided by a specially designed digital pen, supplied with a haptic generator, as explained elsewhere herein. In an embodiment, an audio feedback component may also be provided by the pen supplied with an acoustic generator. In another embodiment, an audio feedback component may be provided by an acoustic system of the tablet.

In order to reproduce the adequate haptic feedback that follows the dynamics of a particular writing trajectory, the system described herein may measure all necessary characteristics of the trajectory using the digital ink capturing system included with the pen, and may transmit to the pen a sufficient amount of data to enable reproduction of haptic (or both haptic and acoustic) feedback, as explained elsewhere herein. Measuring trajectory characteristics and for exchanging data between tablet and pen device may depend on a type of digital pen technology. Thus, an electromagnetic active pen (such as digital pens produced by the Wacom Co., Ltd.) includes an inductor/capacitor which interacts with the antenna coils mounted under the glass and the LCD layers of the tablet. Using a pen with the inductor/capacitor technology, electromagnetic signals transfer information between the pen and the tablet and can be modified to include haptic-acoustic profiles and/or specific instructions on generating tactile or audio signals by the pen. Another active pen system (such as one offered by the EPOS Development, Ltd.) is based on an ultra-sound technology utilizing standard MEMS microphones built into the tablet. Using a digital pen with the ultrasound technology, the digital pen transmits acoustic ultrasonic signals with unique characteristics, which are captured by the built-in microphones; in parallel, the software based receiver triangulates a two or three dimensional position of the pen based on calculating the distance of each microphone from the pen's transmitter. Such ultrasonic pen technology can also be modified by adding a sensor to the pen and returning signals from a tablet to the pen. Other interactive digital pen systems are being developed, capable of measuring trajectory characteristics and transmitting data between the pen and the tablet, including pens that interact with the surface of a capacitive multi-touch tablet, such as the Apple iPad. Any digital pen technology capable of measuring the characteristics of the digital pen trajectory on the tablet surface (for certain technologies, on and over, in certain proximity from the surface), may be modified to transmit the necessary data between the tablet and the pen related to the haptic (or haptic and acoustic) feedback.

A digital pen with haptic and, in some embodiments, haptic and acoustic feedback capabilities, the haptic-acoustic pen, may have two types of functionality. In an embodiment, the pen may not perform intense computing functions, but rather receives necessary data and instructions from the tablet, serving essentially as a thin client with a feedback mechanism. In such an embodiment, small segments of haptic dynamics and audio sequences, feedback segments, may be pre-recorded and stored on the haptic-acoustic pen to be played repeatedly. A dedicated tablet software that may, in embodiments, be either a part of the original handwriting application or may use special enhanced drivers or other system or application level software, receives from the pen runtime trajectory characteristics, calculates necessary haptic and/or acoustic output, and transmits momentary feedback instructions back to the pen, which immediately invokes appropriate feedback portions. In such embodiments, control of the haptic-acoustic pen may be purely local and the pen may not receive and store high-level information, such as types of the drawing surface and the tool. In another embodiment, the haptic-acoustic pen may receive high-level information on the drawing surface and tool and may use trajectory measurements and modeling algorithm in an embedded application to product necessary haptic (and possibly acoustic) feedback. Other embodiments are possible where modeling and execution functions are shared between the tablet and the pen software in different proportions.

The proposed system may include all or some of the following principal and optional hardware and software components:

1. Stylus pen device that can be sensed or otherwise identified on a tablet surface at the touch point or in an area using one or more of digital pen technologies, as explained elsewhere herein.

2. A haptic and, possibly, an acoustic generator with a power source and controllers included with the pen device. The generators respond to instructions, provided by a software application running either on the tablet or the pen. Once calculated on the pen device or calculated on the tablet and transmitted to the pen device, the instructions actuate tactile and/or audio feedback to users depending on the writing surface and the writing tool currently selected and emulated by the software.

3. Additional hardware modules such as a wireless connectivity component set (Bluetooth, Wi-Fi, etc.) optionally included with the pen and capable of receiving instructions transmitted by the tablet and controlling haptic and/or audio feedback generated by the pen.

4. Power generating and accumulating mechanism included with the pen device, which may utilize portion of the kinetic energy provided by the user during the writing and drawing processes for charging the pen and enabling its haptic and acoustic feedback.

5. In the embodiments where the haptic-acoustic pen is programmable, the pen may include a processor, memory (persistent and/or volatile), software programs and mechanisms of their uploading to the pen device, as necessary to execute part of or all instructions used for operating the pen device and generating its haptic-acoustic feedback.

6. Enhanced device drivers may be running on the tablet and may be accessible by diverse software applications on the tablet; such drivers may interoperate with a digital ink capturing system and enable transmitting information between the tablet and pen device, including the characteristics of the pen trajectory. Such drivers may use existing digital pen technologies, as explained elsewhere herein.

7. A main software application running on the tablet and using handwriting and/or drawing input, associated with the movement of the pen over the tablet surface. The application may have multiple types of emulated writing surfaces and writing/drawing tools, as explained elsewhere herein.

8. Haptic and audio profiles associated with some or all combinations of writing surfaces with writing/drawing tools. Such profiles may be built independently of the system and may be based on recording, processing and modeling real-life surfaces and writing/drawing tools. Haptic and audio profiles may represent desirable parameters of tactile and acoustic output and may be utilized by a software application running on the tablet or dedicated software running on the pen device to instruct the haptic and acoustic generators of the pen device on actuating tactile and audio feedback in response to the writing surface/tool currently selected by user, as well as to the momentary characteristics of the handwritten trajectory, such as the writing speed, the acceleration of the pen tip, pressure, tilt, etc. In an embodiment, the audio component of the feedback may be implemented on the tablet instead of the pen.

9. The main software application and the pen may have an autonomous mechanism for communicating with each other, which are separate from the generic driver-based communications channel described in the item #6 above.

A workflow for the haptic-acoustic pen utilizes the above-defined components as follows. Whenever the user:

(i) Selects new handwriting or drawing settings supported by the handwriting application, such as a new writing surface and/or writing tool; and

(ii) Writes on the tablet, utilizing an appropriate digital pen technology,

Then the handwriting application responds by:

(iii) Invoking a haptic and an audio profile specific for that particular combination of the writing surface and tool;

(iv) Calculating the haptic and audio signals along the user's handwritten trajectory based on the measurements of the trajectory characteristics and emulating a corresponding physical use of the writing surface and tool; and

(v) Instructing the haptic-acoustic pen to reproduce the signals, interoperating with the pen via communication channels and mechanisms of the pen, which may, in some embodiments, use enhanced software drivers or/and an autonomous mechanism such as wireless transmissions. In embodiments, the pen may calculate the necessary feedback signals using a software component of the pen, while the audio feedback may be generated by the tablet instead of the pen.

Accordingly, the haptic-acoustic pen performs the following actions:

(vi) Receives instructions from a handwriting application (i.e. from tablet) using modified parameters of the corresponding digital pen technology or other built-in sensors or devices, such as a wireless connection (in embodiments, the pen may calculate the instructions using computing capacity of the pen itself); and

(vii) Provides a haptic feedback (and, in embodiments, an audio feedback) to the user employing built-in haptic (and possibly acoustic) generators.

Simultaneously, a power generating mechanism in the pen device may use part of the kinetic energy produced by the user in the writing process to automatically charge the pen, accumulating the electric energy in a rechargeable battery included with the pen, thus turning a haptic-acoustic pen into a fully or partially self-powered device.

### BRIEF DESCRIPTION OF THE DRAWINGS

Embodiments of the system described herein will now be explained in more detail in accordance with the figures of the drawings, which are briefly described as follows.

FIG. 1 is a schematic illustration of an options pane of a software application with multiple background surface, tool, size, and color choices, according to embodiments of the system described herein.

FIG. 2 illustrates a user interface of a software application with active surface and tool choices and a fragment of handwritten text entered on a given background according to embodiments of the system described herein.

FIG. is schematic illustration of components and assembly of a haptic-acoustic pen device according to embodiments of the system described herein.

FIG. 4 is a schematic functional illustration of a generation process of haptic and acoustic feedback accompanying the writing process according to embodiments of the system described herein.

FIGS. 5A and 5B are high-level system flow diagrams according to embodiments of the system described herein.

### DETAILED DESCRIPTION OF VARIOUS EMBODIMENTS

The system described herein provides a new mechanism for providing feedback to a tablet and digital pen user who employs enhanced handwriting software with multiple writing surfaces and tools. The system augments traditional user experiences based on high quality visual look-and-feel of rendered freehand lines in such software with the tactile and audio feedback, consistent with the type of active drawing surface and tool. Such enhancements rely upon a special construction of the haptic-acoustic pen, constant tracking of the handwritten dynamics and recalculation of feedback characteristics, and permanent communications between the pen and the tablet to generate an adequate physical feedback.

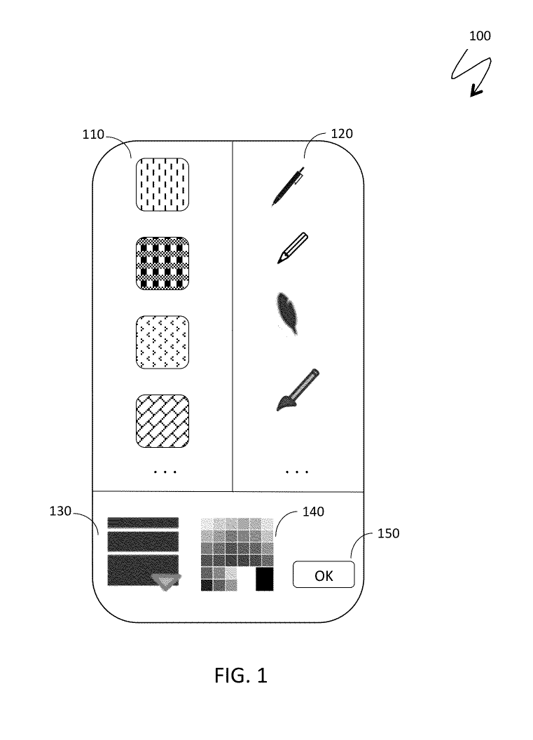

FIG. 1 is a schematic illustration 100 of a software application's options pane with multiple background surface, tool, size, and color choices, according to an embodiment of the system described herein. The options pane is divided into sections, each responsible for selection of certain parameters. A section 110 allows selection of a background, i.e. a simulated writing surface that may emulate user writing over diverse types of surfaces, such as scratch paper, papyrus, recycled, tissue or chalk paper, cardboard, canvas, glass, wood, metal, stone, etc., as schematically shown on the drawing. A section 120 offers a choice of writing/drawing tools that may include pen, pencil, highlighter, quill, brush, chisel, etc. In a bottom section of a schematic options pane, a width scale 130 allows choosing line size, while a color palette 140 offers color choices. The pane is designed in such way that the user may freely browse sections of the pane and select one or several items until the needed options are fully set; after that, a button 150 confirms user choices and closes the pane.

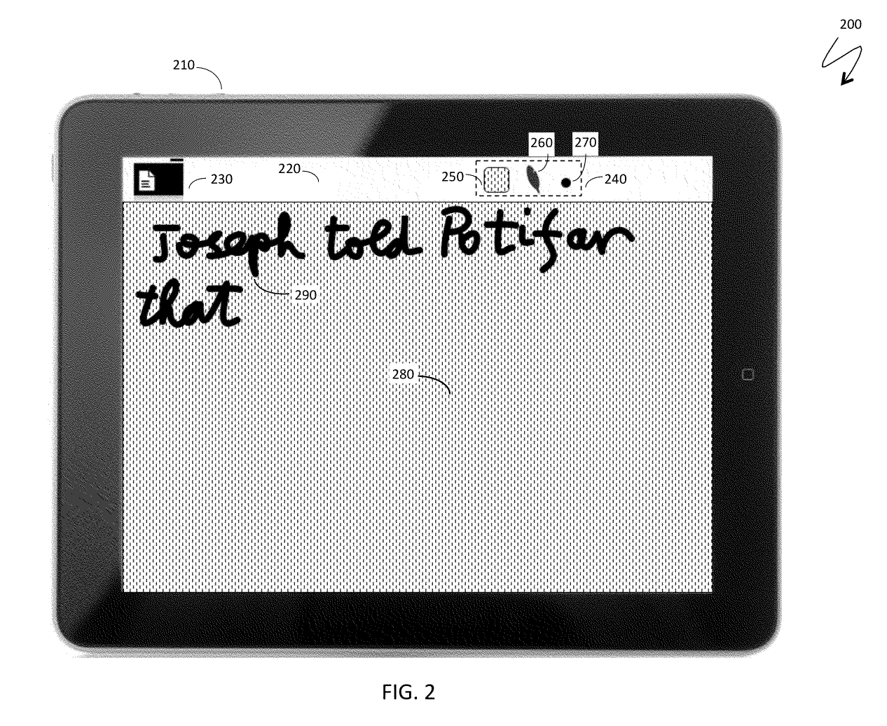

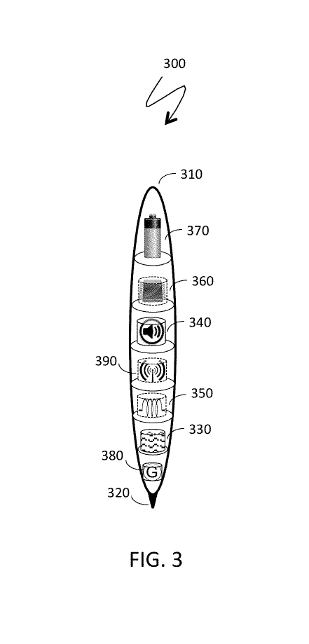

FIG. 2 is a schematic illustration 200 of a user interface of a software application with active surface and tool choices and a fragment of handwritten text entered on a given background according to embodiments of the system described herein. A software application 220 running on a tablet 210 has a generic toolbar schematically shown as a button 230, and a dedicated section 240 of the toolbar showing current drawing options, including a background, or an emulated drawing surface 250 (in FIG. 2, canvas is the drawing material), a drawing tool 260 (in FIG. 2, the quill), and a line width/shape/color indicator 270 (in FIG. 2, black size 2 line with a round pattern). A fragment of handwriting 290 is displayed on a writing surface 280.

FIG. 3 shows a schematic illustration of the components and assembly of a haptic-acoustic pen device 300 according to embodiments of the system described herein. Specifically, FIG. 3 illustrates a version of the haptic-acoustic pen 300 based on an electromagnetic inductive technology. A shell 310 of the digital pen 300 includes a pen tip 320, used for precise positioning of the pen 300 on a tablet, hosts multiple components, described below. A haptic generator 330 actuates device vibrations that emulate resistance of different surfaces, such as friction, abrasion, flexure, etc. when the selected writing tool is writing with given pressure and speed on the selected writing surface. Similarly, an acoustic generator 340 produces an audio feedback, such as a squeak of a writing quill or a rustle of a painting brush. As explained elsewhere herein, both haptic and the acoustic feedback may be based on the pre-recorded feedback segments that are sequentially reproduced by the system and may be repeated. An inductor/capacitor 350 shown in FIG. 3 uses electromagnetic inductive technology for active digital pens where the inductor may interact with antenna coils mounted under the glass and the LCD layers of the tablet, as explained elsewhere herein. A signal transmitted between the inductor/capacitor 350 and the antenna coils may be used to detect an absolute position of the pen on the tablet. In embodiments, the inductor/capacitor 350 may be modified to transmit to the pen 300 feedback instructions using enhanced device driver software.

An embedded processing unit 360, including processor and memory, may be used in some embodiments for processing incoming signals, calculating feedback characteristics and sending instructions to the generators, as explained elsewhere herein. A battery 370 may be used as a replaceable power source. In some embodiments, a power generator 380, coupled to the battery 370, utilizes kinetic energy produced in the writing process so that the battery 370 becomes a rechargeable accumulator. A wireless sensor/receiver 390 may be used as an alternative communications unit that can transmit signals between the tablet and the haptic-acoustic pen. Communication with the pen 300 may be based on Wi-Fi, Bluetooth and/or other RF technologies. It should be noted that both the component set and the particular assembly are provided in FIG. 3 for illustration purpose only to demonstrate a conceptual design of the haptic-acoustic pen 300 and thus are not intended to offer a comprehensive picture or an industrial design of the pen 300. Some necessary components, such as buses and other connections between the components, a pen tip sensor for registering touch with the tablet surface, and other parts, are intentionally omitted for simplicity of illustration.

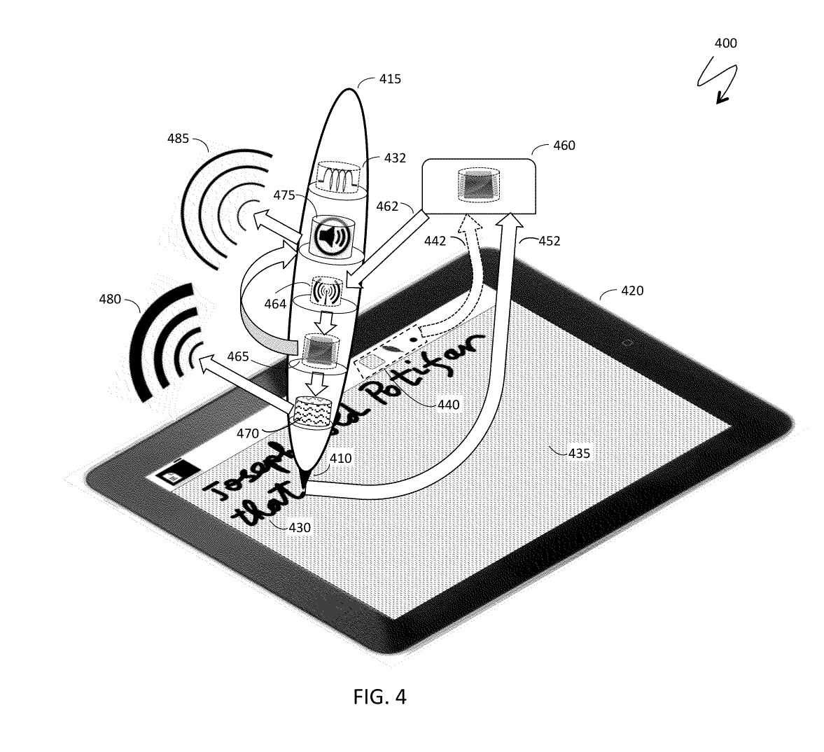

FIG. 4 is a schematic functional illustration 400 of generation process of haptic and acoustic feedback accompanying the writing process according to an embodiment of the system described herein corresponding to electromagnetic inductive technology with an active digital pen 415. A pen tip 410 of the haptic-acoustic pen 415 touches the surface of a tablet 420 and interacts with a handwriting software application running on the tablet, causing handwritten trajectory 430 to appear on a background (a simulated writing surface) 435, according to active pen settings (options) 440. The dynamic (time-stamped) characteristics of the handwritten trajectory, such as the coordinates and pressure of the pen and the pen tilt, and, when necessary, active settings of the surface and tool are measured using an interaction of an inductor/capacitor 432 with the coil antenna on the tablet (not shown here). The characteristics may be transmitted to a software module (utility, application) 460 which processes the trajectory and the settings; the transmission process is illustrated by an arrow 442 (periodic transmission sessions, subject to changes in options) and an arrow 452 (permanent transmission, as long as the user writes with the pen). The processing module 460 may calculate additional dynamic characteristics of the trajectory, for example, writing speed and acceleration; subsequently, the processing module 460 models the physical interaction of the drawing tool with the writing surface, which results in haptic and audio feedback instructions. In different embodiments, the processing module 460 may run either on the tablet or on an embedded processing system 465 of the pen 415. A stream of instructions for haptic and audio feedback may be transmitted to the pen, as illustrated by an arrow 462. The particular illustration of transmission illustrated by the arrow 462 of FIG. 4 corresponds to a case when the processing module 460 is running on the tablet, while the wireless signal transmission is received by the pen 415 to a wireless receiver 464. Accordingly, the signal is transferred to the embedded processing module 465 of the pen 415, which provides appropriate instructions to a haptic generator 470 and an acoustic generator 475 (in other embodiments, the audio feedback may be generated on the tablet). The two generators 470, 475 subsequently actuate haptic feedback 480 and acoustic feedback 485.

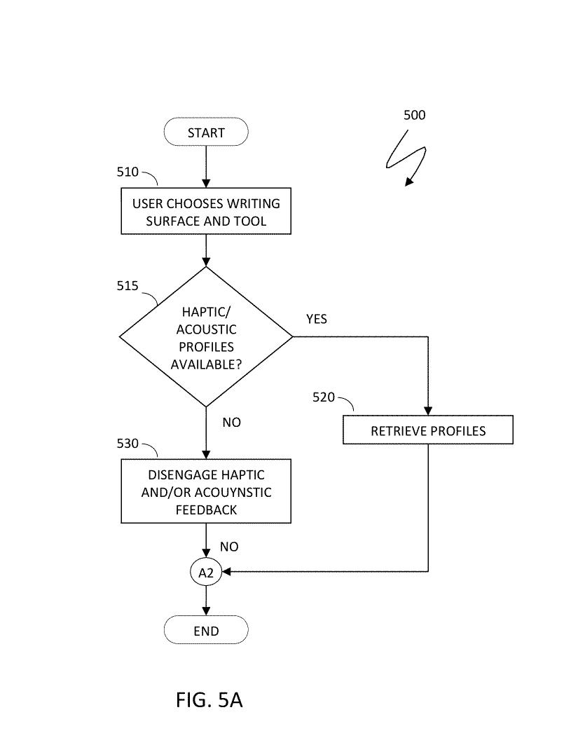

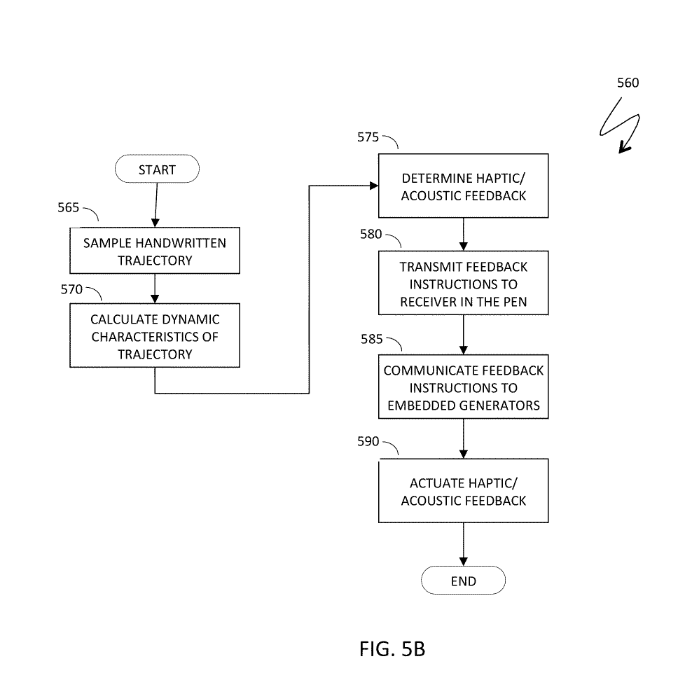

FIG. 5A is a system flow diagram 500 illustrating processing performed in connection with providing settings and retrieving haptic and acoustic profiles for a haptic-acoustic pen according to embodiments of the system described herein. Processing starts at a step 510 where a user selects initial or new writing/drawing options, such as choosing a writing surface and a tool. After the step 510, processing proceeds to a test step 515, where it is verified whether haptic and acoustic profiles for the selected drawing settings are available, as explained elsewhere herein. If so, then processing proceeds to a step 520 where the haptic/acoustic profiles are retrieved by the system; otherwise, processing proceeds to a step 530 where writing with the currently chosen surface and tool are not accompanied by haptic and audio feedback. Following each of the steps 520, 530, processing is complete.

FIG. 5B is a system flow diagram 560 of user and system activities associated with providing haptic-acoustic feedback according to embodiments of the system described herein. Processing begins at a step 565 where the user writes on the tablet with the haptic-acoustic pen and the system samples the corresponding handwritten trajectory and detects the coordinates, pressure, tilt and other characteristics of the trajectory through the available digital pen technology, as explained elsewhere herein (see, for example, item 432 and the accompanying text for FIG. 4). After the step 565, processing proceeds to a step 570, where the system calculates additional dynamic characteristics of the handwritten trajectory (for example, speed and acceleration of the pen tip if the original measurements within the digital pen technology do not provide them), for modeling a physical behavior of the chosen writing tool interacting with the chosen writing surface and for determining the corresponding haptic and acoustic feedback. (See, for example, item 460 of FIG. 4 and the corresponding text).

After the step 570, processing proceeds to a step 575, where the system determines the characteristics of haptic/acoustic feedback according to determinations made at the previous step 570. It should be noted that the calculations at the steps 570, 575 may be performed on the tablet or on the pen, as well as shared in different ways between the tablet and the pen, as explained elsewhere herein. In the flow diagram 560, an assumption is made that the feedback parameters are computed on the tablet. Accordingly, after the step 575, processing proceeds to a step 580, where the calculated feedback parameters are transformed into executive instructions and are transmitted to the receiving sensor in the pen and to the main processing unit in the pen (such as, for example, the wireless receiver 464 and the processing unit 465 illustrated on FIG. 4 and described above). After the step 580, processing proceeds to a step 585, where feedback instructions are communicated to the embedded haptic and acoustic generators. In some embodiments, the instructions may be represented as a stream of pre-recorded audio feedback portions with variable parameters that may be repeated, as explained elsewhere herein. After the step 585, processing proceeds to a step 590, where the embedded generators in the pen execute the instructions and actuate the required haptic/acoustic feedback. Alternatively, acoustic feedback may be generated by the tablet's sound system (not shown in FIG. 5B). After the step 590, processing is complete.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, elements and areas of screen described in screen layouts may vary from the illustrations presented herein. Further, various aspects of the system described herein may be implemented using software, hardware, a combination of software and hardware and/or other computer-implemented modules or devices having the described features and performing the described functions. The mobile device may be a cell phone, although other devices are also possible. The system described herein may be implemented with any type of electronic screen capable of being actuated by a touch screen, electromagnetic or other pen.

Software implementations of the system described herein may include executable code that is stored in a computer readable medium and executed by one or more processors. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A pen for annotating an electronic screen, comprising:
a shell;
a tip provided at one end of the shell; and
a haptic generator, provided in the shell, that provides vibration of the tip and the shell to emulate resistance of different simulated writing surfaces.

2. A pen, according to claim 1, wherein the vibration provided by the haptic generator corresponds to friction, abrasion, and flexure of the simulated writing surfaces.

3. A pen, according to claim 1, wherein the vibration provided by the haptic generator is based on pre-recorded feedback that is reproduced by the haptic generator.

4. A pen, according to claim 1, wherein the vibration provided by the haptic generator is based on a dynamic position of the tip on the electronic screen.

5. A pen, according to claim 4, further comprising:
an inductor/capacitor, disposed within the shell, that interacts with antenna coils of the electronic screen to provide the dynamic position of the tip on the electronic screen.

6. A pen, according to claim 5, wherein the inductor/capacitor provides information regarding pressure and pen tilt which is used to vary the vibration provided by the haptic generator.

7. A pen, according to claim 6, further comprising:
a processor that models physical interaction of a selected emulated drawing tool with the simulated writing surface to provide instructions to the haptic generator based on the information regarding pressure and pen tilt.

8. A pen, according to claim 4, further comprising:
ultrasound technology, disposed within the shell, that provide the dynamic position of the tip on the electronic screen.

9. A pen, according to claim 8, wherein the ultrasound technology provides information regarding pressure and pen tilt which is used to vary the vibration provided by the haptic generator.

10. A pen, according to claim 9, further comprising:
a processor that models physical interaction of a selected emulated drawing tool with the simulated writing surface to provide instructions to the haptic generator based on the information regarding pressure and pen tilt.

11. A pen, according to claim 1, further comprising:
an acoustic generator, provided in the shell, that provides an audio feedback to emulate sound created when writing on the different simulated writing surfaces.

12. A pen, according to claim 11, wherein the sound is selected from the group consisting of: a squeak of a writing quill and a rustle of a painting brush.

13. A pen, according to claim 1, further comprising:
an embedded processing unit, provided in the shell and coupled to the haptic generator, that processes incoming signals, calculates feedback characteristics and sends instructions to the haptic generator.

14. A pen, according to claim 1, wherein processing for signals provided to the haptic generator is provided by a device containing the electronic screen.

15. A method of providing feedback to a user actuating a pen on an electronic screen, comprising:
determining dynamic characteristics of handwritten trajectory for modeling a physical behavior of a writing tool chosen by the user; and
actuating the pen with a haptic generator according to the dynamic characteristics of handwriting trajectory.

16. A method, according to claim 15, wherein the dynamic characteristics of handwriting trajectory include coordinates, pressure, tilt, speed and acceleration of a tip of the pen.

17. A method, according to claim 15, wherein a processor on the pen determines the dynamic characteristics of handwriting trajectory.

18. A method, according to claim 15, further comprising:
actuating an acoustic generator of the pen according to the dynamic characteristics of handwriting trajectory.

19. Computer software, provided in a non-transitory computer-readable medium, that provides feedback to a user actuating a pen on an electronic screen, the software comprising:
executable code that determines dynamic characteristics of handwritten trajectory for modeling a physical behavior of a writing tool chosen by the user; and
executable code that actuates the pen with a haptic generator according to the dynamic characteristics of handwriting trajectory.

20. Computer software, according to claim 19, wherein the dynamic characteristics of handwriting trajectory include coordinates, pressure, tilt, speed and acceleration of a tip of the pen.

21. Computer software, according to claim 19, wherein a processor on the pen determines the dynamic characteristics of handwriting trajectory.

22. Computer software, according to claim 19, further comprising:
executable code that actuates an acoustic generator of the pen according to the dynamic characteristics of handwriting trajectory.
